(19) United States
(12) Patent Application Publication
(10) Pub. No.: US 2020/0184486 A1
(43) Pub. Date: Jun. 11, 2020

(54) Method and Apparatus for Tracking an Edible Consumable

(71) Applicant: Underground Farms, LLC, New Vernon, NJ (US)

(72) Inventor: William F. Spoor, New Vernon, NJ (US)

(73) Assignee: Underground Farms, LLC, New Vernon, NJ (US)

(21) Appl. No.: 16/215,025

(22) Filed: Dec. 10, 2018

(51) Int. Cl. G06Q 30/00; G06Q 10/08; A01K 29/00; A01K 11/00; G06Q 50/02

(52) U.S. Cl. CPC G06Q 30/018; G06Q 10/0833; G06Q 50/02; A01K 11/006; A01K 29/005

(57) ABSTRACT

A method and apparatus for tracking animal protein intended for consumption includes receiving completed questionnaires from a person associated with a farm. The completed questionnaires are stored in a database and subsequently compared by management, an algorithm, or a combination of management and an algorithm, to a set of standards. If the answers to the questionnaires meet the standards, the server on which the database is stored generates a unique quick response (QR) code that identifies a specific animal protein intended for consumption that is produced by one specific farm and is indexed to a robust amount of data points that are of interest to the consumer, including farm details, customer's distance from the farm, the entire supply chain and details pertaining to the sourcing, raising and processing of the animal, in a standardized, easy-to-read embodiment.

### FIELD OF THE INVENTION

The present disclosure relates generally to tracking food, and more particularly, to tracking an edible consumable, such as animal protein intended for consumption, from birth of a related animal up to the time of consumption.

### BACKGROUND

Historically for mankind, whether grouped in hunter-gatherer communities or modern urban dwellings, nothing is more important than securing a consistent source of healthy animal protein for consumption. In America in the 1930's, consumers were intimately familiar with the animal proteins they ate, since they would buy their meats and poultry from local, often family-run, farms. Because the independent American family farms were such an important part of early-century communities, the people were aware of the origination of the flocks and herds, the practices supported by the farm, the food and water given to the livestock, and other elements of the animals' pasture-centric lives.

Typically, a big corporation with significant scale and capital will lower prices until its competitors are driven out of business. Unfortunately, that explains a lot of what has happened to the independent American family farmer over the past century, as giant farming conglomerates and big agribusiness have absorbed market share and taken over the industry. According to estimates, the number of farms in the United States has fallen from about 6.8 million in 1935 to about 2 million today. Independent farmers are unable to compete with large-scale industrial conglomerates: according to Rural Advancement International—USA, with respect to livestock, three companies control ˜60% of the poultry market, four control ˜70% of the pork market, and four control ˜85% of the beef market.

Furthermore, large-scale industrial meat conglomerates have, in recent years, come under heavy criticism for utilizing sub-standard practices in the pursuit of operational efficiencies. To name a few: (i) overcrowding of animals in factory warehouses; (ii) suppression of natural behavior and mutilation of animals; (iii) administration of sub-therapeutic antibiotics to animals to compensate for unhygienic living conditions; (iv) lack of accountability regarding the administration of growth-promoting hormones to animals; (v) lack of information regarding slaughterhouse conditions; (vi) lack of disclosure regarding chemicals used in meat-packing; (vi) lack of tracking and transparency regarding supply chain logistics such as point-of-origin, distance travelled, transportation routes and handling practices in effect until the animal proteins intended for consumption reach the final point-of-sale.

Since large-scale industrial meat conglomerates have been allowed to grow, nearly uninterrupted, for decades, each of the major meat and poultry companies have built massive supply chains across rural America that are complex, inefficient, and resistant to change. As described in “The Meat Racket” by Christopher Leonard, the system that currently connects factory-farms, high-tech processing facilities, distribution centers, warehouses, and rail and trucking lines passes along multiple hidden costs to the consumer: a rancher in Colorado might sell cattle to a meatpacker in Austin, Tex., who then ships the beef back to a Wal-Mart in Colorado. Altering any single part of these chains is cumbersome, and very little, if any, of this supply chain information is disclosed to the consumer.

### SUMMARY

A method and apparatus for tracking an edible consumable includes maintaining a database of parameters related to edible consumables (e.g. animal protein obtained from animals). The parameters related to the edible consumables can include animal husbandry parameters, processing parameters, and transportation parameters. The edible consumables can be from a plurality of sources. Animals can be processed by a plurality of processors to produce edible consumables. A unique identifier associated with a particular edible consumable (e.g., a cut of meat) is received from a user device. The user device generates the unique identifier based on a quick response (QR) code that is scanned by the user device. Parameters associated with the particular edible consumable are retrieved from a database of edible consumables. The retrieved parameters are transmitted in response to receiving the unique identifier. The animal husbandry parameters can include general farm parameters, general herd parameters, general flock parameters, sourcing parameters, animal specific husbandry practices, feed parameters, healthcare parameters, animal management parameters, water management parameters, environment parameters, and finishing parameters. In one embodiment, a location of a device that transmitted the unique identifier is determined and can be used to determine a distance from a one of the plurality of sources associated with the particular edible consumer. An identifier of the distance can be transmitted in response to receiving the unique identifier.

### BRIEF DESCRIPTION OF THE DRAWINGS

FIG. 1 depicts a block diagram of parameters related to raising an animal to be converted into an edible consumable (e.g., animal protein intended for consumption);

FIG. 2 depicts a diagram showing how animals are moved from farms, processed, and transported to consumers;

FIG. 3 depicts an overview of the process of obtaining information pertaining to edible consumables according to an embodiment;

FIG. 4 depicts types of information collected from a farmer pertaining to farm topics according to one embodiment;

FIG. 5 depicts types of information collected from a farmer pertaining to general animal topics according to one embodiment;

FIG. 6 depicts types of information collected from a farmer pertaining to sourcing topics according to an embodiment;

FIG. 7 depicts types of information collected from a farmer pertaining to husbandry topics according to an embodiment;

FIG. 8 depicts types of information collected from a farmer pertaining to feed topics according to an embodiment;

FIG. 9 depicts types of information collected from a farmer pertaining to health topics according to an embodiment;

FIG. 10 depicts types of information collected from a farmer pertaining to management topics according to an embodiment;

FIG. 11 depicts types of information collected from a farmer pertaining to water management topics according to an embodiment;

FIG. 12 depicts types of information collected from a farmer pertaining to environment topics according to an embodiment;

FIG. 13 depicts types of information collected from a farmer pertaining to finishing topics according to an embodiment;

FIG. 14 depicts a farmer self-certification according to an embodiment;

FIG. 15 depicts standards used to evaluate answers provided to information collected regarding animal husbandry practices of farms responding to the questionnaire according to an embodiment;

FIG. 16 depicts a method for providing a user with information pertaining to animal protein intended for consumption according to an embodiment;

FIG. 17 depicts a schematic showing how information concerning animal protein intended for consumption is acquired and retrieved according to an embodiment; and

FIG. 18 depicts additional information that can be displayed to a user according to an embodiment;

FIG. 19 depicts a table containing records pertaining to edible consumables;

FIG. 20 depicts a block diagram of a system for tracking edible consumables;

FIG. 21 depicts a flow chart of a method for tracking an edible consumable according to an embodiment; and

FIG. 22 depicts a high-level block diagram of a computer that can be used to implement various devices.

### DETAILED DESCRIPTION

The amount of information currently available from large-scale industrial meat conglomerates about the origin, welfare, food and drug inputs, processing, packaging and transportation of edible consumables is insufficient to provide the consumer with the level of knowledge commensurate with what he or she requires in order to make informed food choices. Edible consumables, in one embodiment, are animal proteins intended for consumption. Although the phrase “animal proteins intended for consumption” is used throughout this disclosure, it should be understood that the methods described herein can be used for any edible consumable.

The large-scale industrial meat conglomerates have reshaped America's rural economies by organizing a tightly-integrated system of corporations that determine how animals are raised, how much farmers get paid, and how meat is processed and transported: all while reaping enormous profit and remaining almost entirely opaque to the consumer. As a result, market demand is rising for animal proteins produced by independent family-owned farms that disclose their animal management practices and supply chains to the marketplace.

However, the amount of information currently available about animal proteins intended for consumption that are sold by independent family-owned farms suffers from lack of agreed-upon standards regarding: (i) how animals are raised; (ii) where animals are raised. In the first case, a lack of clarity attaches to words like “organic,” “pasture-raised,” and “grass-fed”: in the absence of third-party verification, the use of such terms on labels can mislead or even deceive consumers about the animal husbandry practices in use by the farm. In the second case, a lack of clarity attaches to words like “local” or “regional’: unless customers buy directly from a farm they know, they could be purchasing food anywhere from 100 miles away that loosely qualifies as “local,” and up to 450 miles away that loosely qualifies as “regional.” The term “local” isn't officially defined or monitored, so it can be defined by the distance to market, staying within certain city or state borders, or even by divergent geographical or regional boundaries. Nevertheless, labeling products “organic” or “local” is often used to justify a significant price increase on the animal proteins intended for consumption that are sold by independent family-owned farms. It should be noted: this strategy is occasionally used in the marketing of the animal proteins intended for consumption that are sold by large-scale industrial meat conglomerates, often without corroborating or supporting documentation.

The food industry is attempting to solve this problem by creating and enforcing uniform standards that address issues such as the origin, welfare, food and drug inputs, processing, packaging and transportation of animal proteins intended for consumption. However, to date, these efforts are hampered on the one hand by the reluctance of large-scale industrial meat conglomerates to make such information available to the public, and on the other hand by the inability of independent family-owned farms to find the time and money necessary to undergo a complex, costly, often multi-year certification process. What is needed is a way to allow the market to differentiate between factory-farmed animal proteins and the higher-quality animal proteins sold by independent family farmers. Differently put, what is needed is a way to quickly and inexpensively surface data on independent family farm operations to the marketplace as regards animal proteins intended for consumption.

The present disclosure pertains to a technical solution to a systemic social problem. The problem is that there is not a single standardized system that informs people of how and where animal proteins intended for consumption are raised, processed and delivered. A grocery store, delicatessen or restaurant may receive animal protein intended for consumption that was produced at any of a number of farms and processed at any of a number of processing facilities, that has changed hands multiple times and undergone refrigeration, flash-freezing, or other interim conditions, without documentation, before finally arriving at the point-of-sale. For example, a person purchasing a steak in a grocery store, delicatessen or restaurant has no information about how the cattle the steak came from were raised, processed or how far the animal protein had travelled and what conditions it had undergone before reaching the marketplace.

A solution to this problem is a method for providing information to a consumer of animal protein intended for consumption. In one embodiment, the method consists in querying farmers as to the details of their operations, gathering their replies in a database of information, maintaining a database, evaluating the farm's practices in relation to a set of health and safety standards, assigning a unique quick response (QR) code to each protein intended for consumption that is produced by that farm, and then sharing a curated subset of that information with the marketplace in a standardized embodiment in order to support pricing and facilitate sales. The method uses a unique identifier that is associated with a particular animal protein intended for consumption that can be scanned by a user device in order to obtain information about the animal protein intended for consumption that is relevant to the consumer. For example, a customer at a restaurant can scan a QR code located on a sign or on a menu in order to retrieve information concerning animal protein that they are interested in ordering. In a grocery store or delicatessen, a shopper can scan a QR code located on packaging of an animal protein intended for consumption or a QR code located on a sign associated with the animal protein intended for consumption in order to retrieve information concerning animal protein they may decide to purchase. Or, a consumer might decide to shop online, and be able to receive the same standardized, easy-to-read embodiment regarding animal proteins intended for consumption.

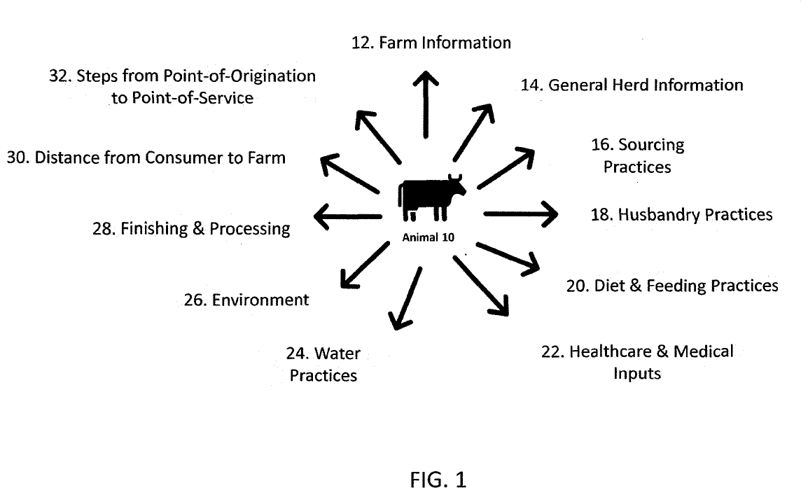

FIG. 1 depicts parameters related to raising animal 10. Animal 10, in one embodiment, is a farm animal, such as a cow, pig, goat, lamb, turkey, chicken, etc. The parameters related to raising animal 10 include farm 12 which identifies where the animal was raised. General herd information 14 (also referred to as general herd parameters) specifies certain cyclical practices of farm 12 at which animal 10 was bred. In one embodiment, general herd information 14 can also pertain to general flock information (also referred to as general flock parameters). Sourcing practices 16 (also referred to as sourcing parameters) can include an identification of the origination of certain animals in a herd or flock, or the entirety of a herd or flock. Husbandry practices 18 (also referred to as animal specific husbandry parameters) indicate what practices on a farm govern mating, pregnancy, birth and care of offspring. In one embodiment, husbandry practices pertain to a particular animal and are referred to as animal specific husbandry practices Diet and feeding practices 20 (also referred to as feed parameters) identify the inputs (e.g., foods) that are administered to the animals by mouth and, in some embodiments, the regularity with which they receive such food as may be distributed. Healthcare practices 22 (also referred to as healthcare parameters) specify the substances that are administered to animals either to prevent illness and infection or as a result of illness and infection. Water practices 24 (also referred to as water management parameters) specify the sourcing, distribution and availability of water to the herd or flock. Environment 26 (also referred to as environment parameters) indicates the size, type, coverage and composition of the living area of the animals raised by the farm. Finishing (also referred to as finishing parameters) and processing 28 identifies the procedures that may be in place to prepare the animal for eventual processing by making significant changes to diet, feeding, exercise or other inputs. Distance from consumer to farm 30 identifies the distance from a consumer to the location of farm 12 where the animal protein was raised. In one embodiment, distance from consumer to farm 30 is used to determine if the animal protein intended for consumption deserves to be referred to as local insofar as the farm of origin is operating within geographical parameters that any reasonable person would consider to be proximate. In one embodiment, the steps from point-of-origin to the point-of-service are inclusive of pick-up at the farm, drop off and pick up from the processing facility, and delivery to either the consumer or the grocery store, delicatessen, restaurant or other location of the end user of the animal protein intended for consumption.

The parameters shown in FIG. 1 represent data sets that are commonly unavailable to consumers of animal proteins, especially as regards how the animals used to make the animal protein intended for consumption were raised and processed, as well as the distance to the farm of origin, and every step in the supply chain. It should be noted that, in one embodiment, general farm parameters, general herd parameters, general flock parameters, sourcing parameters, animal specific husbandry practices, feed parameters, healthcare parameters, animal management parameters, water management parameters, environment parameters, and finishing parameters are collectively referred to as animal husbandry parameters.

As regards the meat industry's contemporary supply chain practices, the problem of determining information concerning an animal and animal products is exacerbated by the animal and animal products being transported to numerous locations before arriving at point-of-sale.

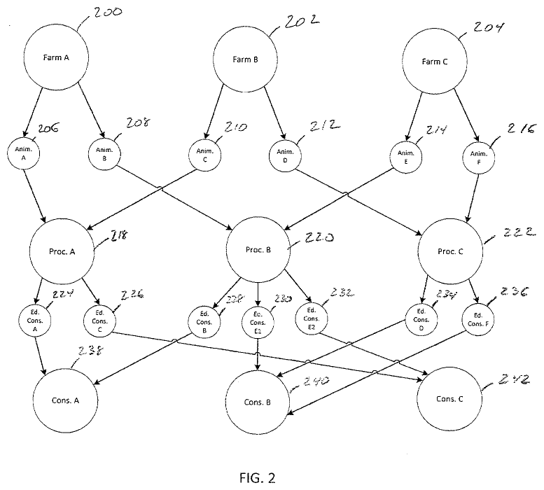

FIG. 2 depicts a diagram illustrating how animals are moved from the farms at which they were raised to processing facilities and then to consumers. Farm A 200 raises animal A 206 and animal B 208 which are transported to processing facility A 218 and processing facility B 220, respectively. Animal A 206 is processed at processing facility A 218 to produce animal protein intended for consumption A 224 which is transported to consumer A 238. Animal B 208 is processed at processing facility B 220 to produce animal protein intended for consumption B 228 which is transported to consumer A 238.

Farm B 202 raises animal C 210 and animal D 212 which are transported to processing facility A 218 and processing facility C 222, respectively. Animal C 210 is processed at processing facility A 218 to produce animal protein intended for consumption C 226 which is transported to consumer C 242. Animal D 212 is processed at processing facility C 222 to produce animal protein intended for consumption D 234 which is transported to consumer B 240.

Farm C 204 raises animal E 214 and animal F 216 which are transported to processing facility B 220 and processing facility C 222, respectively. Animal E 214 is processed at processing facility B 220 to produce animal protein intended for consumption E1 230, which is transported to consumer B 240, and to produce animal protein intended for consumption E2 232, which is transported to consumer C 242. Animal F 216 is processed at processing facility C 222 to produce animal protein intended for consumption F 236 which is transported to consumer B 240.

It should be noted that animals A through F can be any type of animal raised on one of farms A through C. For example, animals A through F can be any combination of a steer, a pig, a goat, a lamb, a turkey, etc. Animal proteins intended for consumption A through F can be any of a variety of animal products such as portions of an animal that is processed at one of processing facilities A through C. Finally, consumers A through C can be any combination of a restaurant, grocery store, delicatessen, end consumer, etc. As shown in FIG. 2, a person purchasing an animal protein intended for consumption may not be able to determine where the animal protein intended for consumption can from or how the related animal was raised and processed due to the quagmire created by transportation and processing.

In order to provide information about an animal protein intended for consumption, various data is obtained and stored to track an animal protein intended for consumption from farm to consumer.

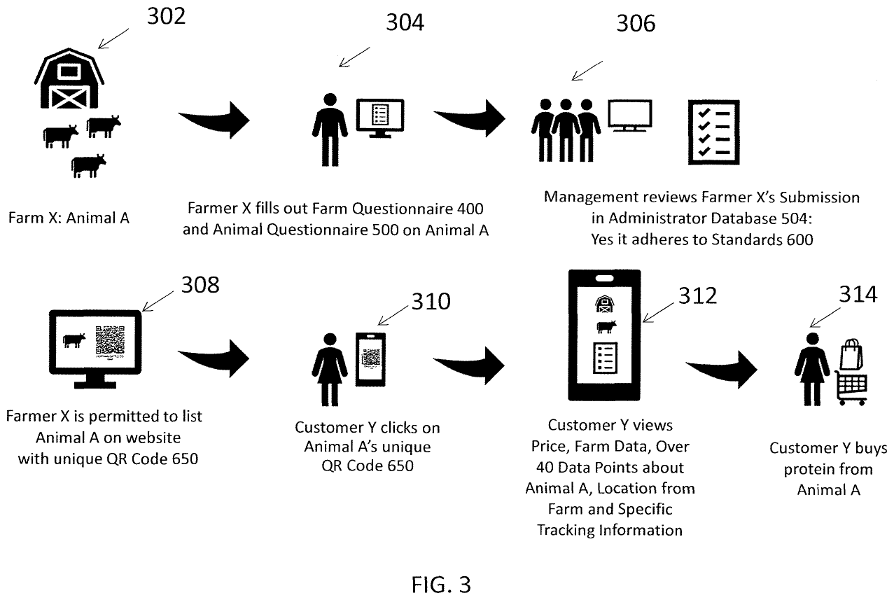

FIG. 3 provides an overview of how information concerning animals and animal proteins intended for consumption is obtained and stored in a database, and if it meets relevant standards, is used to generate a QR code indexed to a standardized, easy-to-read format for use by the end consumer.

A farm 302 is shown having animals. At step 304, a person associated with a farm completes farm questionnaire 400 and animal questionnaire 500 which are transmitted to administrator database 504. At step 306, a server on which administrator database 504 is located compares data from farm questionnaire 400 and animal questionnaire 500 to standards 600 which are stored in administrator database 504. In one embodiment, this comparison is performed using an algorithm. Alternatively, the comparison can also be performed by a management team or a combination of an algorithm and a management team. In one embodiment, the management team comprises individuals associated with maintaining server and/or administrator database 504 and are referred to as the management. If the information provided in farm questionnaire 400 and animal questionnaire 500 satisfies standards 600, that information is transmitted to and stored in administrator database 504. At step 308, a unique QR code 650 is assigned to the individual animal protein intended for consumption based on the answers to farm questionnaire 400 and animal questionnaire 500, combined with pricing information, portion information, the distance from the farm to the consumer, and every step in the supply chain, in a standardized, easy-to-read format, which is then listed on a website and made accessible to consumers. In one embodiment, the website is controlled by management. Customers in locations serviced by management, for instance, local restaurants, grocery stores and delicatessens, can scan the QR code 650 as shown at step 310 and review multiple data points regarding the animal protein intended for consumption as shown at step 312, and purchase as shown at step 314.

In one embodiment, all information gathered, such as the information gathered using farm questionnaire 400 and animal questionnaire 500 are stored in administrator database 504. In one embodiment, the stored information is only presented to users other than management if the information is approved by the management or if the answers to farm questionnaire 400 and animal questionnaire 500 satisfy standards 600.

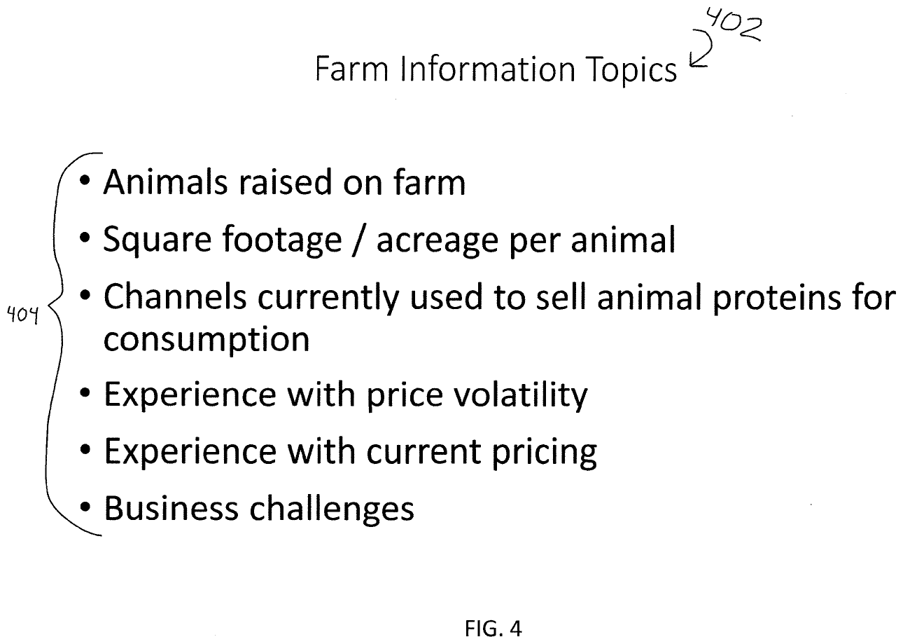

FIG. 4 depicts farm questionnaire 400 according to one embodiment, which is used to obtain information about a farm. Title 402 identifies farm questionnaire 400 as a “Farm Information Topics.”

Questions 404 comprise multiple questions pertaining to a farm that are to be answered, including the kind of animal proteins the farm sells (e.g., Beef, Pork, Goat, Lamb, Turkey, Chicken, or other).

Questions 404, in one embodiment, can also include additional questions concerning the farm, such as questions concerning farm acreage. Farm acreage questions can include questions concerning number of acres of the farm, number of acres dedicated to farming, number of acres dedicated to raising livestock, and square acreage (or square footage) allocated to each animal.

Questions 404 can also include questions concerning how the farm currently sells its animals, including which channels are currently used by the farm to sell its animals, if the experience with those channels was good or bad, and how much time is spent looking for additional channels.

Questions 404 can also include questions concerning pricing including whether a farmer experiences price volatility, the farmer's experience with the current pricing and whether he or she considers the amounts that the market offers to be commensurate with the expenditures required to raise animals under the parameters acknowledged in farm questionnaire 400.

Questions 404 can also include questions involving the farmer's perception of market trends, the competitive landscape, and any particular elements of farming that the farmer finds himself or herself struggling with, whether that involves the sourcing of animals, the raising of animals, specific healthcare concerns, variations in the demand cycle, or concerns about servicing new customers and finding additional customers.

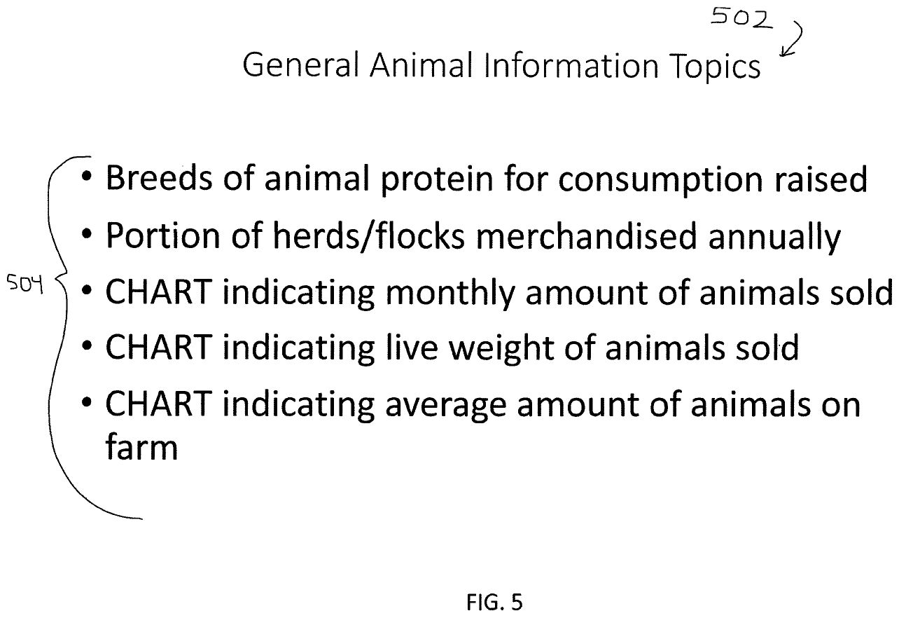

FIG. 5 depicts a portion of animal questionnaire 500 which is used, in one embodiment, to obtain information about the animals and/or animal products a farmer wants to sell. Title 502 identifies “General Information Topics” that are presented to the farmer.

Questions 504, in one embodiment, cover the following topics in depth: breed information, the portion of herds/flocks that are merchandised annually and can require the farmer to complete a chart that indicates the monthly number of animals sold from the farm premises.

Questions 504 can also require the farmer to provide information in a chart detailing the live weight of the animals that he or she brings to market that are to be sold as animal protein intended for consumption.

Questions 504 can also require the farmer to disclose a chart indicating how many animals are on the farm at any given month, in order to better ascertain the monthly and seasonal variation of flocks and herds.

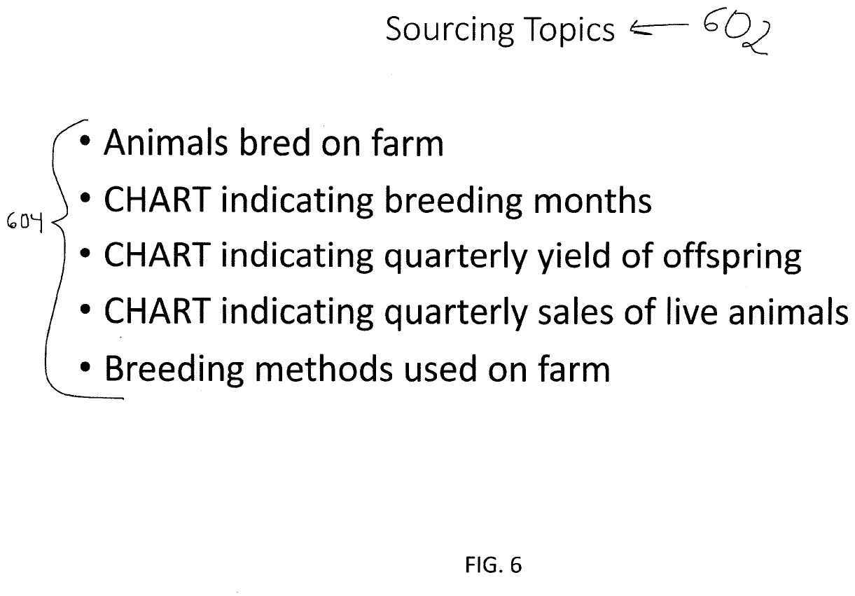

FIG. 6 depicts a portion of animal questionnaire 500 which is used, in one embodiment, to obtain information about the animals and/or animal products a farmer wants to sell. Title 602 identifies “Sourcing Topics” that are presented to the farmer.

Questions 604, in one embodiment, can include questions about the animals that are bred on the farm, for instance, cattle, pigs, sheep, goats, turkeys, chickens, etc. and to complete a chart indicating the months of the year during which active breeding takes place on the farm.

Questions 604 can also include questions as to the amount of offspring this activity generates quarterly and can require disclosure of the sales of live animals that this yield generates, again on a quarterly basis.

Questions 604 can also include questions as to the breeding methods used on the farm, for instance, does the farmer use natural or artificial insemination processes, does the farmer produce and store semen from animals he or she raises or does he or she procure semen from a third-party distributor or breeding association, and if so, which ones, and can also inquire about the maintenance of records to this effect.

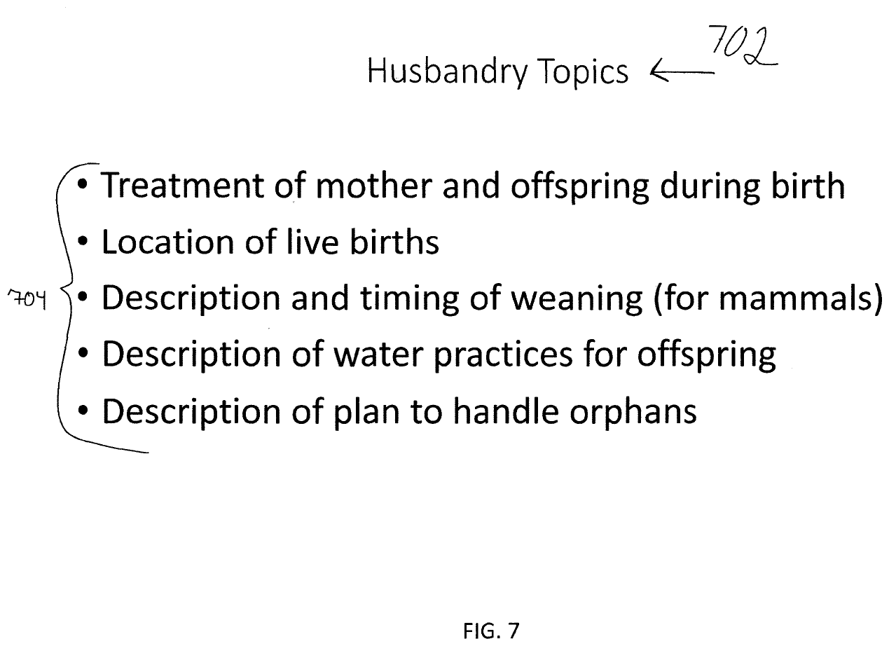

FIG. 7 depicts a portion of animal questionnaire 500 which is used, in one embodiment, to obtain information about the animals and/or animal products a farmer wants to sell. Title 702 identifies “Husbandry Topics” that are presented to the farmer.

Questions 704, in one embodiment, can include questions about the farm's practices regarding the health and welfare of the mother and the offspring during birth, and whether such births take place indoors or outdoors, or if the mother has free choice in this circumstance.

Questions 704 can also include questions as regards mammalian live births (cattle, pigs, sheep, lambs, etc.) and questions about the practices surrounding how long the offspring is allowed to nurse, the procedures utilized in the weaning process, and the average age of the offspring when weaned.

Questions 704 can also include questions about sourcing and availability of water to the offspring, which may differ from the practices used for the larger herds or flocks.

Questions 704 can also include questions about the procedures in place on the farm to resolve situations in which the mother succumbs to illness or injury, leaving behind an orphan or orphans.

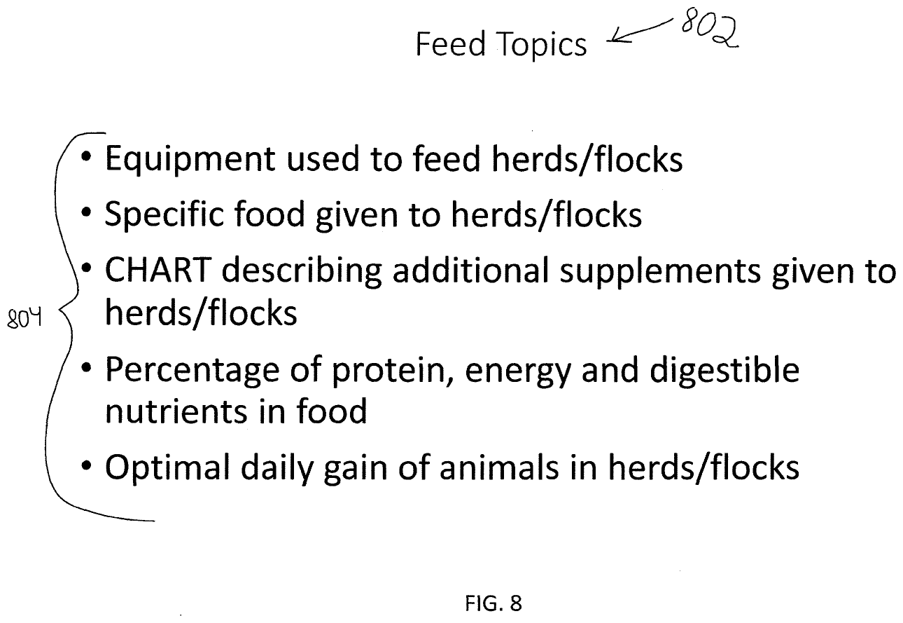

FIG. 8 depicts a portion of animal questionnaire 500 which is used, in one embodiment, to obtain information about the animals and/or animal products a farmer wants to sell. Title 802 identifies “Feed Topics” that are presented to the farmer.

Questions 804, in one embodiment, can include questions about the specific equipment and systems that are in place to feed the herds or flocks.

Questions 804 can also include questions about the food given to herds and flocks and questions about the sourcing and composition of the most typical foodstuffs: hay, grain, minerals, concentrates and silage.

Questions 804 can also include a chart requesting identification of any and all additional foods or by-products fed to the animals and can also request identification of the amount given to each animal, the frequency with which the food or by-product is provided, and the rationale for so doing.

Questions 804 can also include questions about the percentage of protein, energy and digestible nutrients that comprise the food that is given to the flocks and/or herds.

Questions 804 can also include questions about the optimal daily gain for the average animal of the specific type being queried in this portion of the animal questionnaire 500.

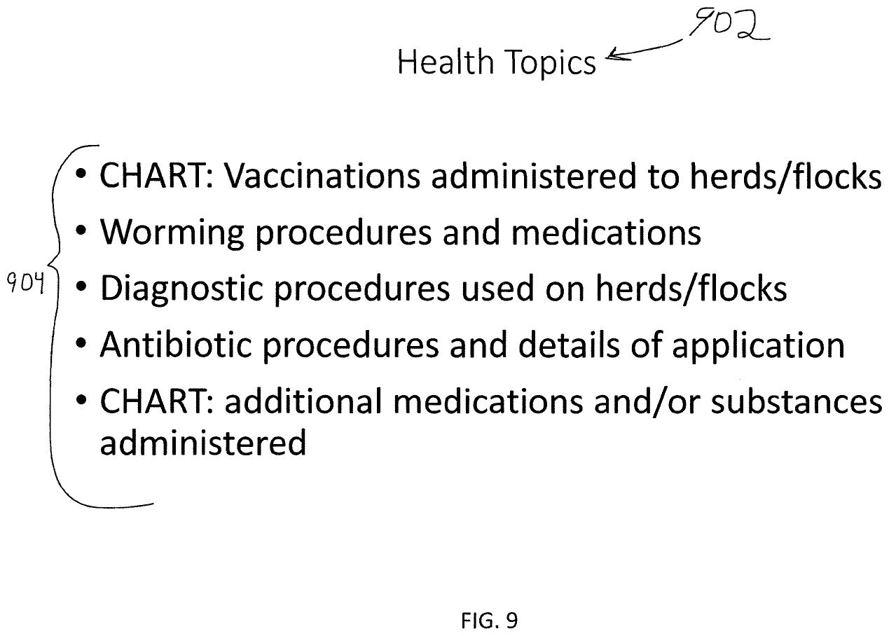

FIG. 9 depicts a portion of animal questionnaire 500 which is used, in one embodiment, to obtain information about the animals and/or animal products a farmer wants to sell. Title 902 identifies “Health Topics” that are presented to the farmer.

Questions 904, in one embodiment, can include a chart requesting identification of all vaccinations administered to the animals, and can request the name, dosage amount, rate of application, age of application and rationale for administering.

Questions 904 can also include questions about the procedures in use, if applicable, for keeping the animals free of worms.

Questions 904 can also include questions about how the animals are diagnosed with more serious illnesses and if the farmer consults with a local veterinarian.

Questions 904 can also include questions about any plans to tend to sick or suffering animals as regards the administration of antibiotics. If antibiotics are administered, a chart must be completed detailing the type of antibiotic, the dosage, the rate of application, the age of application and the reason for antibiotic use.

Questions 904 can also include questions about other medications and/or substances that are administered to the animals; if so, in one embodiment, a chart must be completed detailing the type of antibiotic, the dosage, the rate of application, the age of application and the reason for this additional medication or substance use.

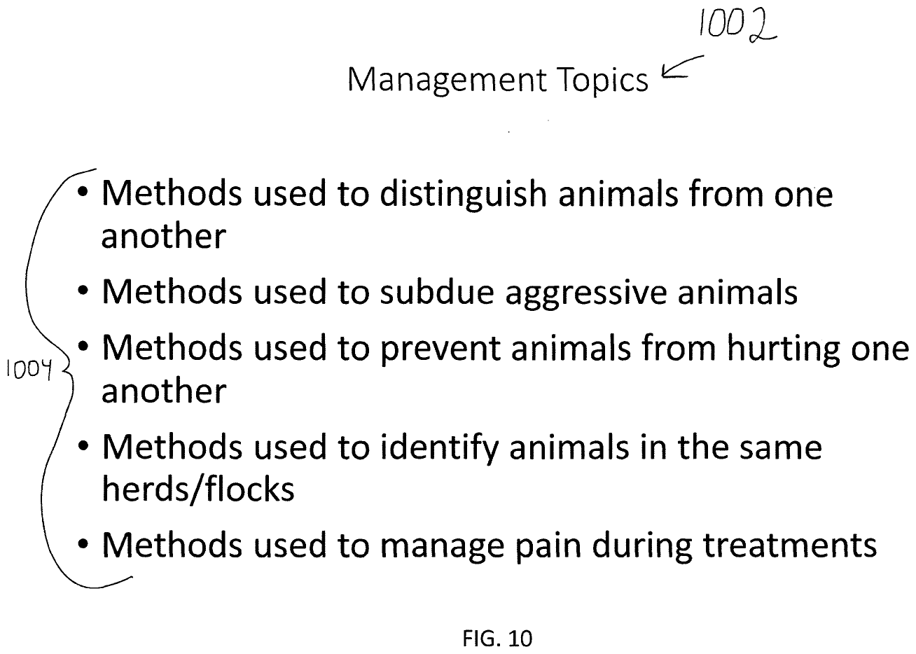

FIG. 10 depicts a portion of animal questionnaire 500 which is used, in one embodiment, to obtain information about the animals and/or animal products a farmer wants to sell. Title 1002 identifies “Health Topics” that are presented to the farmer.

Questions 1004, in one embodiment, can include questions distinguishing one animal from another, for instance, through freeze branding, hot branding, ear notching, ear tagging, neck banding or tattooing.

Questions 1004 can also include questions about the methods the farmer utilizes to subdue aggressive animals as well as how the farmer prevents the animals from hurting one another.

Questions 1004 can also include questions about how the farmer distinguishes his or her animals from other animals in nearby flocks or herds, with reference to the methods of marking animals outlined above (see paragraph 0066).

Questions 1004 can also include questions about which pain management practices are utilized, and if so, what they consist of and which conditions they are meant to ameliorate.

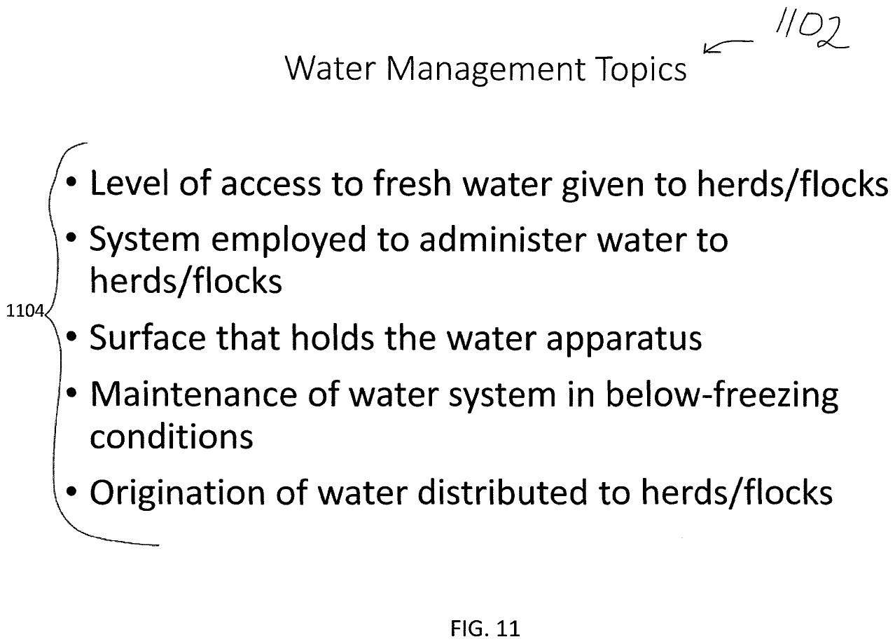

FIG. 11 depicts a portion of animal questionnaire 500 which is used, in one embodiment, to obtain information about the animals and/or animal products a farmer wants to sell. Title 1102 identifies “Water Management Topics” that are presented to the farmer.

Questions 1102, in one embodiment, can include questions about whether the animals have unrestricted access to water in their environment.

Questions 1102 can also include questions about how water is provided to the animals; in particular, what system or systems are in place to ensure that animals have a consistent supply of fresh water.

Questions 1102 can also include questions about the surface upon which the water apparatus and/or containers are kept.

Questions 1102 can also include questions to determine if back-up systems are in place to ensure that animals have a fresh supply of drinking water even in below-freezing conditions.

Questions 1102 can also include questions about the source of the water given to the flocks and herds; specifically, does the water originate from a natural source, such as a lake, river, or well, or a municipal water system.

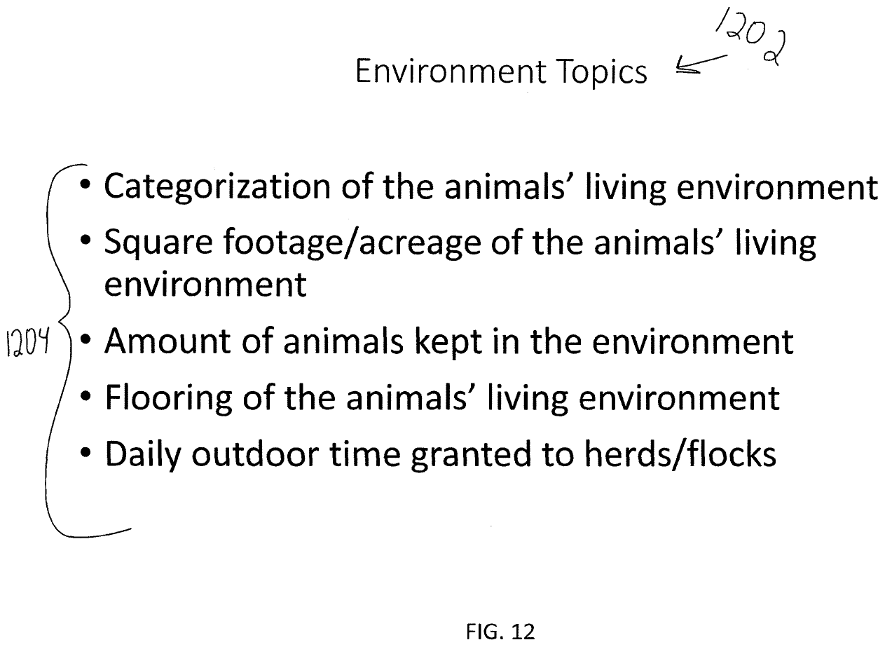

FIG. 12 depicts a portion of animal questionnaire 500 which is used, in one embodiment, to obtain information about the animals and/or animal products a farmer wants to sell. Title 1202 identifies “Environment Topics” that are presented to the farmer.

Questions 1204, in one embodiment, can include questions about the living environment of the animals, and the degree of outdoor access as well as shelter from inclement weather conditions that is structurally enabled by the environment.

Questions 1204 can also include questions about the average square footage and/or square acreage allocated to each of the animals in the designated living environment.

Questions 1204 can also include questions about the largest number of animals, at any one time, that are required to coexist within the designated living environment.

Questions 1204 can also include questions about the specifications of the kind of flooring on which the animals are required to eat, defecate and sleep.

Questions 1204 can also include questions about the amount of time the animals are kept indoors, if they are required to spend small or large portions of each day outside, or if they are given free choice as to whether they spend time indoors or outdoors.

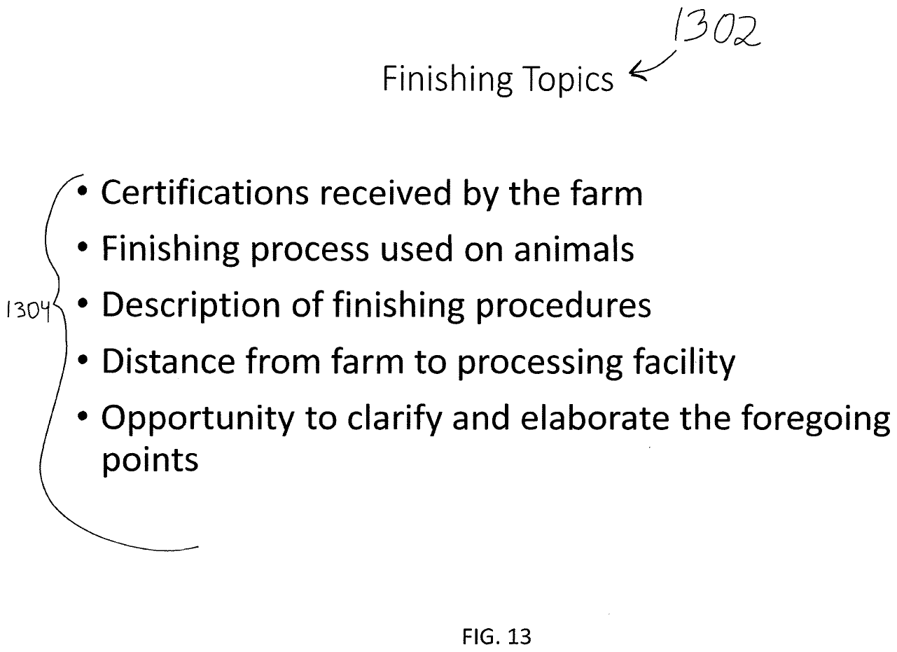

FIG. 13 depicts a portion of animal questionnaire 500 which is used, in one embodiment, to obtain information about the animals and/or animal products a farmer wants to sell. Title 1302 identifies “Finishing Topics” that are presented to the farmer.

Questions 1304, in one embodiment, include questions about whether the farm has been the recipient of any third-party certifications (Certified Organic, Certified Humane, etc.).

Questions 1304 can also include questions about any procedures that may be in place to prepare the animal for eventual processing by making significant changes to diet, feeding, exercise or other inputs. If a finishing process is used, the farmer is asked to provide a written description of the parameters surrounding and informing the practice.

Questions 1304 can also include questions about the distance that the flock or herd travels from the farm to the processing facility.

Questions 1304 can also provide the farmer with incentive and ample room to detail any aspect of the foregoing that might still remain unclear, in order to allow the management team to be better able to evaluate the suitability of the farm for representation on, for example, a digital platform.

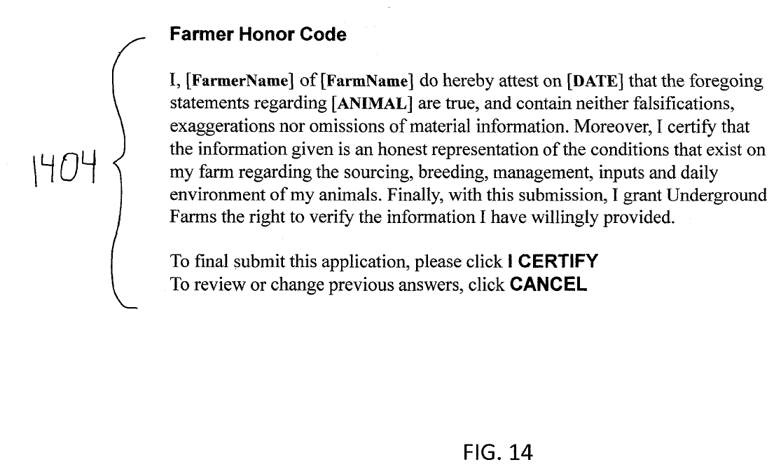

FIG. 14 depicts a portion of animal questionnaire 500, according to one embodiment, pertaining to self-certification 1404 of the farmer who has completed the forms. The farmer provides his or her name, the name of the farm, and attests on the current date that the statements made regarding the animal they are submitting for consideration are not falsifications, nor exaggerations, nor omit any material information that would render them invalid. Furthermore, the farmer certifies that the information provided is an honest representation of the conditions pertaining on the farm regarding sourcing, breeding, management, inputs and the daily environment of the animals under his or her care. Finally, the farmer agrees to grant management the right to inspect the farm at any time to verify that conditions are in complete agreement with the conditions documented in animal questionnaire 500. In one embodiment, self-certification 1404 is required for submission of the animal questionnaire 500. This allows for comparison of the answers to the questionnaires to a set of standards and also allows for review of the answers by management.

In one embodiment, information gathered from a farmer using farm questionnaire 400 and animal questionnaire 500 is compared to a set of standards 600 that are required to be met in order to be eligible to sell animal products on a digital platform controlled by the management.

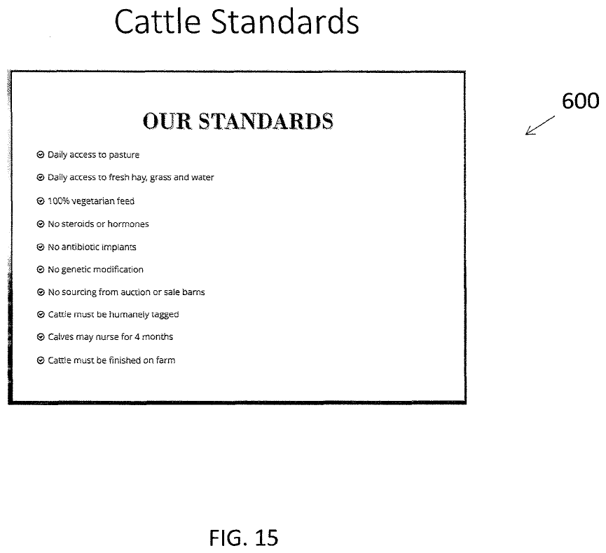

FIG. 15 depicts a sample set of standards 600 for animal proteins intended for consumption that are derived from cattle according to one embodiment. Different standards can be presented for different types of animal proteins intended for consumption. The standards that are presented for each of the animal proteins intended for consumption have been developed over several years in dialogue with local farmers who raise livestock including but not restricted to cattle, pork, sheep, goat, turkey and chicken. The standards 600 have been designed to eliminate unnecessary suffering of animals, minimize questionable inputs that may compromise human health, and promote practices that result in nutrient-dense animal proteins intended for consumption.

The information gathered using farm questionnaire 400 and animal questionnaire 500 is stored in an administration database (e.g., administration database 504 shown in FIG. 3) as a table of records. This information can then be compared to the standards 600 described above.

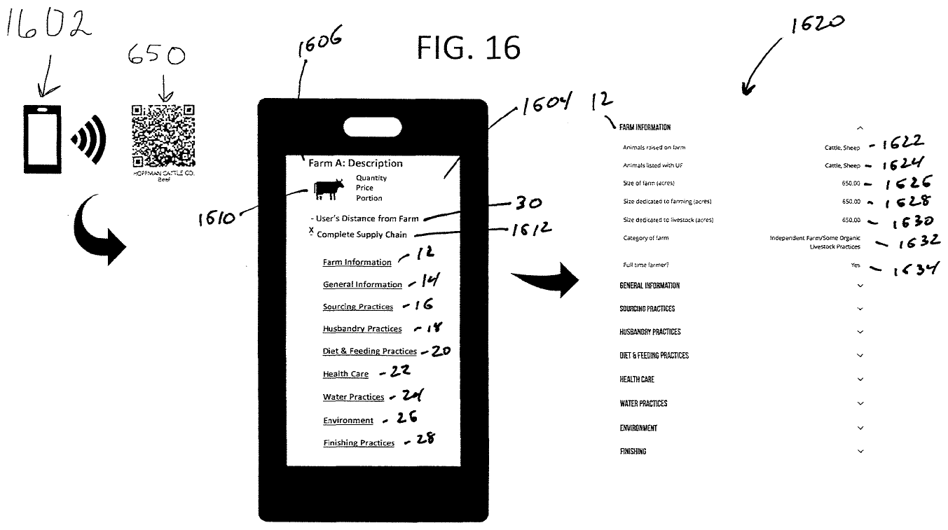

FIG. 16 illustrates how a user, such as a consumer, can use a device, such as a smart phone, to obtain information concerning an animal protein intended for consumption. User device 1602 scans QR code 650 that, in one embodiment, is a unique identifier associated with an animal protein intended for consumption. QR code 650 contains data that user device 1602 can use to retrieve information administrator database 504 (shown in FIG. 3) in which data pertaining to animal protein intended for consumption is stored. For example, QR code 650 can be located on a menu in a restaurant and scanned by user device 1602. QR code 650 identifies information pertaining to an animal protein that can be retrieved the administrator database 504 in order to be displayed to the user.

QR code 650, in one embodiment is generated by a server on which administrator database 504 is stored. QR code 650, in one embodiment, is generated in response to a request from the server. Generated QR codes can be (i) displayed on the digital platform, (ii) sent to grocery stores, delicatessens or restaurants, (iii) viewed by shoppers on their personal devices 1602.

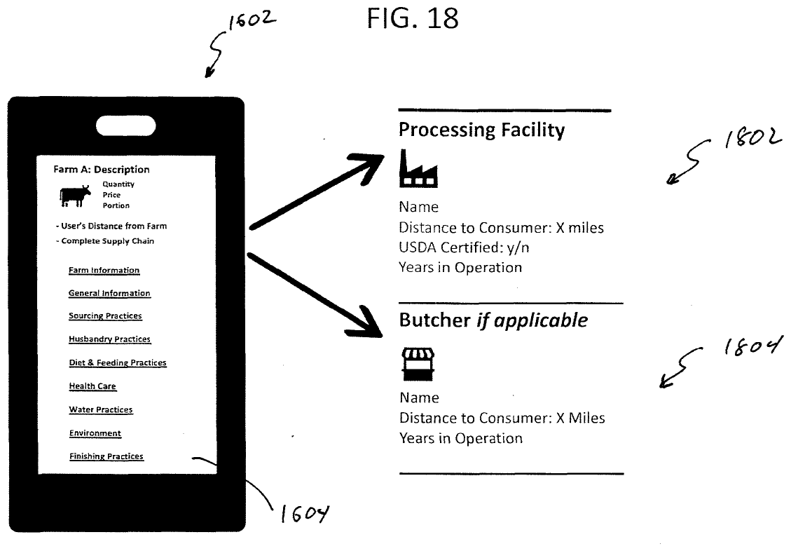

Display 1604 of user device 1602 depicts information displayed to a user in response to the user scanning QR code 650 using a scanning device (e.g., a camera) of user device 1602 according to an embodiment. Name 1606 identifies a name of an entity (e.g., a farm) that provided the animal protein intended for consumption. Image 1610 is an image selected for display associated with the farm identified by name 1606. In one embodiment, various text shown on display 1604 of user device 1602 can be selected (e.g., highlighted or hovered over using a mouse and clicked on or selected by touch using a touch screen) in order to display detailed information about the farm identified by name 1606. Location 30 identifies the user's current distance from the farm which can be determined as described in detail below. Complete supply chain information 1612 is text that can be selected to display information concerning a supply chain as described in further detail below in connection with FIG. 18. Farm information 12 is text shown on display 1604 of user device 1602 that can be selected in order to display information pertaining to the farm identified by name 1606. General information 14 is text shown on display 1604 of user device 1602 that can be selected in order to display information pertaining to the farm identified by name 1606. Sourcing practices 16 is text shown on display 1604 of user device 1602 that can be selected in order to display information pertaining to the sourcing practices of the farm identified by name 1606. Husbandry practices 18 is text shown on display 1604 of user device 1602 that can be selected in order to display information pertaining to the husbandry practices of the farm identified by name 1606. Diet and feeding practices 20 is text shown on display 1604 of user device 1602 that can be selected in order to display information pertaining to the diet and feeding practices of the farm identified by name 1606. Health care practices 22 is text shown on display 1604 of user device 1602 that can be selected in order to display information pertaining to health care of animals on the farm identified by name 1606. Water practices 24 is text shown on display 1604 of user device 1602 that can be selected in order to display information pertaining to the watering practices of the farm identified by name 1606. Environment 26 is text shown on display 1604 of user device 1602 that can be selected in order to display information pertaining to the environment of the farm identified by name 1606. Finishing Practices 28 is text shown on display 1604 of user device 1602 that can be selected in order to display information pertaining to the finishing of animals on the farm identified by name 1606.

Screen shot 1620 depicts information shown on display 1604 of user device 1602 after farm information 12 has been selected. Selection of farm information 12 causes additional information pertaining to the farm identified by name 1606 to be shown on display 1604 of user device 1602 including animals raised on farm 1622, animals listed with management 1624, size of the farm 1626, size dedicated to farming 1628, size dedicated to livestock 1630, category of farm 1632, and full time farmer 1634 which is an indication as to whether the person running the farm is a full time farmer.

The information displayed to a user as described in conjunction with FIG. 16 is based at least in part on, in one embodiment, the answers provided to farm questionnaire 400 and animal questionnaire 500.

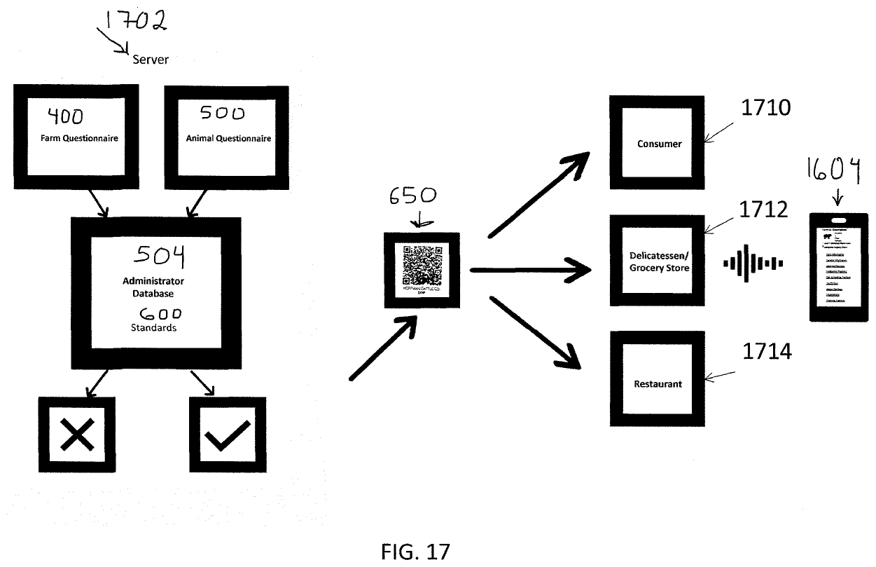

FIG. 17 depicts a flow of information that results in a standardized, easy-to-read format of information related to an animal protein intended for consummation. The information related to the animal protein intended for consumption is generated using information from QR code 650. Each of a plurality of independent family farms complete farm questionnaire 400 and animal questionnaire 500 for each of the animal proteins intended for consumption (e.g., Beef, Pork, Goat, Lamb, Turkey, Chicken, or other), that he or she wants to sell through the digital platform controlled by management and submits it after completing the self-certification process 1404 to the administration database 504, housed in server 1702. Upon comparison with standards 600, management may deny or approve the animal questionnaire 500. Upon approval of animal questionnaire 500, a unique QR code 650 is generated that can be displayed on a website and disseminated to consumer 1710, delicatessen/grocery store 1712 and/or restaurant 1714, that, when scanned, displays a standardized, easy-to-read embodiment containing useful data about the animal protein intended for consumption, including: animal 10, farm 12, distance from consumer to the farm 30, supply chain information 1610 (which can include specific information on which animal processor 218, 220, 222 of FIG. 3 has been utilized), general flock/herd information 14, sourcing practices 16, husbandry practices 18, diet and feeding practices 20, healthcare practices 22, water practices 24, environmental conditions 26, finishing and processing practices 28.

In one embodiment, additional information concerning a processing facility that processed an animal to produce an animal protein intended for consumption is available to a user. Also, additional information concerning a butcher that processed an animal to produce an animal protein intended for consumption is available to a user.

FIG. 18 depicts user device 1602 displaying complete supply chain 1612 text which can be selected by a user to display processing facility information and/or butcher information. Selecting complete supply chain text 1612, in one embodiment, causes processing facility information 1802 to be displayed. Information pertaining to a processing facility can include one or more of a name of the processing facility, a distance from the processing facility to the consumer, an indication as to whether the processing facility is United States Department of Agriculture (USDA) certified, and an identification of a number of years the processing facility has been in operation. In one embodiment, selecting complete supply chain text 1612 causes butcher information 1804 to be displayed. Information pertaining to a butcher, who may have rendered an animal carcass further than a processing facility, can include one or more of a name of the butcher, a distance from the butcher to the consumer, and an identification of a number of years the butcher has been in operation.

In one embodiment, information pertaining to a processing facility and/or a butcher can be entered by a farmer. For example, a farmer can enter processing facility and/or butcher information using sections of animal questionnaire 500 that pertain to those entities. Alternatively, processing facility and/or butcher information can be entered by a management team. Information entered by the management team as regards the processing facility and/or information entered by the management team as regards the butcher can be selected by a farmer completing the animal questionnaire. For example, a drop down menu of all processing facilities and/or butchers that have provided information can be displayed to a farmer via the animal questionnaire. The farmer can then select the applicable processing facility and/or butcher from the drop down menu.

In one embodiment, if the information gathered using farm questionnaire 400 and animal questionnaire 500 satisfies standards 600, then the information is stored in a database (e.g., administrator database 308 shown in FIG. 3) as a table of records.

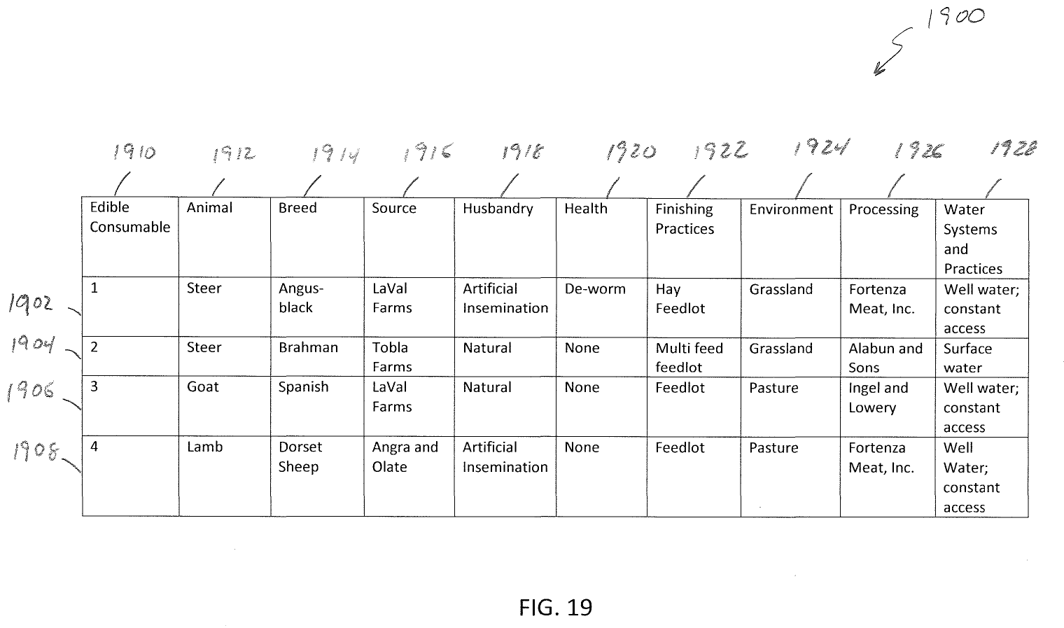

FIG. 19 depicts table 1900, according to one embodiment, having multiple records 1902, 1904, 1906, and 1908 each of which contains information pertaining to a particular edible consumable identified in the column titled edible consumable 1910. It should be noted that table 1900 shows only some of the parameters described above in connection with FIG. 1. Also, additional parameters can be included in table 1900 as needed or desired. As shown in FIG. 19, each edible consumable record contains information concerning animal 1912, breed 1914, source 1916, husbandry 1918, health 1920, finishing practices 1922, environment 1924, processing 1926, water systems and practices 1928.

In one embodiment, the distance between a consumer and one of various entities including a consumer to a farm, distance from a consumer to a processing facility, and the distance from a consumer to a butcher is determined based on a location of user device 1602 when QR code 650 is scanned. For example, user device 1602 can determine its location at the time QR code 650 is scanned and determine a distance between the consumer and one of the entities. In one embodiment, the determined location of the user device is transmitted to server 1702 which will calculate the desired distance or distances for display and transmit the distance data to user device 1602. In one embodiment, the location of user device 1602 is determined by identifying a location of an Internet Protocol address of a network node that user device 1602 is in communication with (or is in range of the network node). Alternatively, the location of user device 1602 can be determined using other systems such as a global navigation satellite system using a global positioning system receiver incorporated into user device 1602.

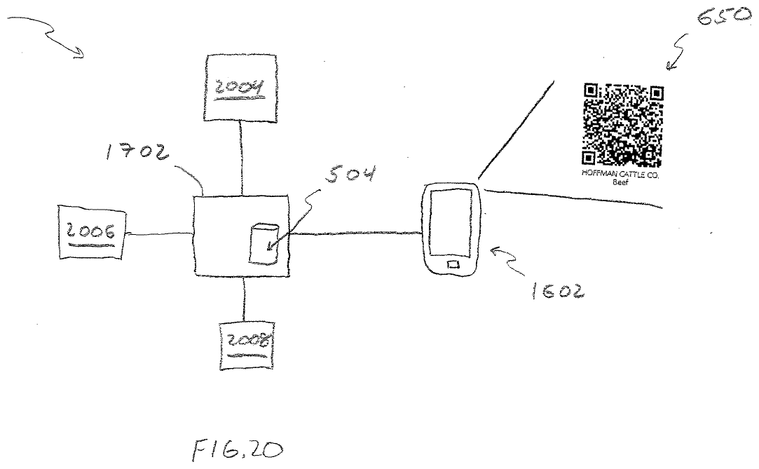

FIG. 20 depicts a system 2000 for tracking an edible consumable (e.g., an animal protein intended for consumption) according to one embodiment. The system can be used to scan QR code 650 that, in one embodiment, is a unique identifier associated with an edible consumable. User device 1602 is an electronic device such as a smartphone which is capable of scanning QR code 650. QR code 650 contains data that user device 1602 can use to retrieve information from server 1702 on which edible consumable database (also referred to as administrator database) 504 is stored. For example, QR code 650 located on a menu in a restaurant can be scanned by user device 1602 which identifies information pertaining to an animal protein that can be retrieved from server 1702 in order to be displayed to the user. Edible consumable data is maintained in edible consumable database 504 of server 1702. The edible consumable data can be obtained from administrator device 2004, processing facility device 2006, and farm device 2008.

QR code 650, in one embodiment is generated by server 1702 based on information contained in database 504. QR code 650, in one embodiment, is generated in response to a request from administrator device 2004. Generated QR codes can be electronically sent to a processing facility prior to transportation of edible consumables to consumers or resellers, such as restaurants or grocery stores. Generated QR codes can also be sent to consumers or resellers, such as restaurants or grocery stores.

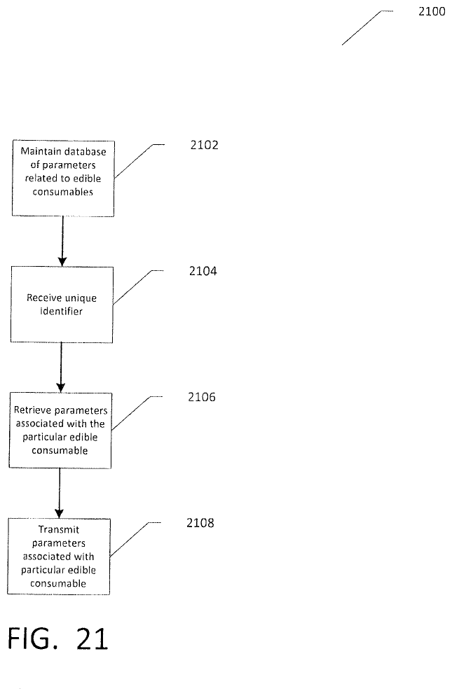

FIG. 21 depicts a flow chart of a method 2100 for tracking edible consumables from a farm to a consumer (e.g., a grocery store, restaurant, or other type of purchase point) according to one embodiment. The method begins at step 2102 where a database (database 504 shown in FIG. 17) of parameters related to edible consumables is maintained. Maintaining the database includes receiving information from a farmer via farm device 2008. In one embodiment, the information from farm device 2008 includes answers to farm questionnaire 400 and animal questionnaire 500. Information in the database can also include information from processing facility device 2006 in order to track edible consumables transported to a consumer (e.g., one of consumer A 238, consumer B 240, and consumer C 242 shown in FIG. 2). At step 2104, a unique identifier is received from user device 1602. In one embodiment, the unique identifier is based on a QR code (such as QR code 650 shown in FIG. 20). User device 1602 scans the QR code and interprets the information contained in the QR code in order to determine the unique identifier. At step 2106, parameters pertaining to the edible consumable identified by the unique identifier are retrieved from database 504. At step 2108, the parameters pertaining to the edible consumable retrieved from database 504 are transmitted to user device 1602 for display. In one embodiment, the display of information is in a format as shown in FIG. 16. In one embodiment, the information provided to user device 1602 at step 2108 comprises a subset of approximately 40 data points gathered from farm questionnaire 400 and animal questionnaire 500.

In one embodiment, the parameters related to edible consumables comprise environmental parameters of a related one of the plurality of sources, health parameters, processing parameters of a related one of the plurality of animal processors (e.g., a processing facility), first transportation parameters (e.g., transportation from farm to processing facility), and second transportation parameters (e.g., transportation from processing facility to a consumer). The environmental parameters, health parameters, and the first transportation parameters, in one embodiment, are received by the database from the related one of the plurality of sources. The processing parameters and second transportation parameters, in one embodiment, are received by the database from the related one of the plurality of animal processors.

In one embodiment, the environmental parameters can comprise data related to an environment in which an edible consumable is developed, the health parameters comprise data related to a health history of an edible consumable, and the harvesting parameters comprise data related to processing of an edible consumable.

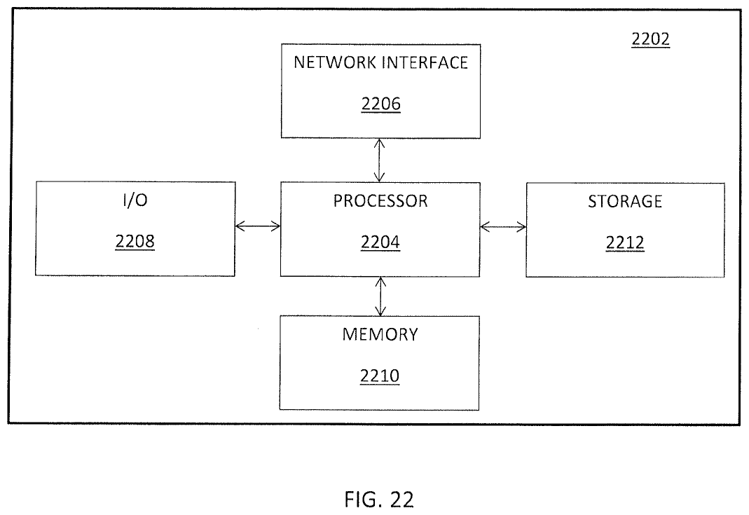

User device 1602, server 1702, processing facility device 3006, farm device 2008, and administrator device 2004 can be implemented using a computer. A high-level block diagram of such a computer is illustrated in FIG. 22. Computer 2202 contains a processor 2204 which controls the overall operation of the computer 2202 by executing computer program instructions which define such operation. The computer program instructions may be stored in a storage device 2212, or other computer readable medium (e.g., magnetic disk, CD ROM, etc.), and loaded into memory 2210 when execution of the computer program instructions is desired. Thus, the method steps of FIG. 21 can be defined by the computer program instructions stored in the memory 2210 and/or storage 2212 and controlled by the processor 2204 executing the computer program instructions. For example, the computer program instructions can be implemented as computer executable code programmed by one skilled in the art to perform an algorithm defined by the method steps of FIG. 21. Accordingly, by executing the computer program instructions, the processor 2204 executes an algorithm defined by the method steps of FIG. 21. The computer 2202 also includes one or more network interfaces 2206 for communicating with other devices via a network. The computer 2202 also includes input/output devices 2208 that enable user interaction with the computer 2202 (e.g., display, keyboard, mouse, speakers, buttons, etc.) One skilled in the art will recognize that an implementation of an actual computer could contain other components as well, and that FIG. 22 is a high level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for tracking edible consumables comprising:
maintaining a database of parameters related to edible consumables, the edible consumables originating from a plurality of sources and processed by a plurality of animal processors;
receiving a unique identifier associated with a particular edible consumable;
retrieving parameters associated with the particular edible consumable identifying one of the plurality of sources and one of the plurality of animal processors; and
transmitting the parameters associated with the particular edible consumable in response to receiving the unique identifier.

2. The method of claim 1, wherein the parameters related to edible consumables comprise:
animal husbandry parameters;
processing parameters of a related one of the plurality of animal processors;
first transportation parameters; and
second transportation parameters.

3. The method of claim 2, wherein the animal husbandry parameters and first transportation parameters are received from the related one of the plurality of sources.

4. The method of claim 2, wherein the processing parameters and the second transportation parameters are received from the related one of the plurality of animal processors.

5. The method of claim 2, wherein the animal husbandry parameters comprise one or more of general farm parameters, general herd parameters, general flock parameters, sourcing parameters, animal specific husbandry practices, feed parameters, healthcare parameters, animal management parameters, water management parameters, environment parameters, and finishing parameters.

6. The method of claim 2, further comprising:
identifying a location of a device that transmitted the unique identifier.

7. The method of claim 2, further comprising:
determining a distance from the device to one of the plurality of sources associated with the particular edible consumable; and
transmitting an identifier of the distance in response to receiving the unique identifier.

8. The method of claim 2, wherein the transportation parameters comprise data related to transportation of an animal before and after processing of the animal into an edible consumable.

9. The method of claim 1, wherein the unique identifier associated with the particular edible consumable is based on a quick response code.

10. An apparatus comprising:
a processor; and
a memory to store computer program instructions, the computer program instructions when executed by the processor cause the processor to perform operations comprising:
maintaining a database of parameters related to edible consumables, the edible consumables originating from a plurality of sources and processed by a plurality of animal processors;
receiving a unique identifier associated with a particular edible consumable;
retrieving parameters associated with the particular edible consumable identifying one of the plurality of sources and one of the plurality of animal processors; and
transmitting the parameters associated with the particular edible consumable in response to receiving the unique identifier.

11. The apparatus of claim 10, wherein the parameters related to edible consumables comprise:
animal husbandry parameters;
processing parameters of a related one of the plurality of animal processors;
first transportation parameters; and
second transportation parameters.

12. The apparatus of claim 11, wherein the animal husbandry parameters and first transportation parameters are received from the related one of the plurality of sources.

13. The apparatus of claim 11, wherein the processing parameters and second transportation parameters are received by the database from the related one of the plurality of animal processors.

14. The apparatus of claim 11, wherein the animal husbandry parameters comprise one or more of general farm parameters, general herd parameters, general flock parameters, sourcing parameters, animal specific husbandry practices, feed parameters, healthcare parameters, animal management parameters, water management parameters, environment parameters, and finishing parameters.

15. The apparatus of claim 11, further comprising:
identifying a location of a device that transmitted the unique identifier.

16. The apparatus of claim 11, further comprising:
determining a distance from the device to one of the plurality of sources associated with the particular edible consumable; and
transmitting an identifier of the distance in response to receiving the unique identifier.

17. The apparatus of claim 11, wherein the transportation parameters comprise data related to transportation of an animal before and after processing of the animal into an edible consumable.

18. The apparatus of claim 10, wherein the unique identifier associated with the particular edible consumable is based on a quick response code.

19. A computer readable medium storing computer program instructions, which, when executed by a processor, cause the processor to perform operations comprising:
maintaining a database of parameters related to edible consumables, the edible consumables originating from a plurality of sources and processed by a plurality of animal processors;
receiving a unique identifier associated with a particular edible consumable;
retrieving parameters associated with the particular edible consumable identifying one of the plurality of sources and one of the plurality of animal processors; and
transmitting the parameters associated with the particular edible consumable in response to receiving the unique identifier.

20. The computer readable medium of claim 19, wherein the parameters related to edible consumables comprise:
animal husbandry parameters;
processing parameters of a related one of the plurality of animal processors;
first transportation parameters; and
second transportation parameters.
